(19) United States
(12) Patent Application Publication
(10) Pub. No.: US 2022/0256878 A1
(43) Pub. Date: Aug. 18, 2022

(54) PULSE PROTEIN EMULSIFIERS

(71) Applicant: CORN PRODUCTS DEVELOPMENT, INC, WESTCHESTER, IL (US)

(72) Inventors: Quyen NGUYEN, Bridgewater, NJ (US); Brandon ROA, Bridgewater, NJ (US); Bicheng WU, Bridgewater, NJ (US)

(21) Appl. No.: 17/618,924

(22) PCT Filed: May 29, 2020
(86) PCT No.: PCT/US2020/035039

§ 371 Date: Dec. 14, 2021

Related U.S. Application Data
(60) Provisional application No. 62/863,147, filed on Jun. 18, 2019.

(51) Int. Cl. A23D 7/005; A23L 11/00; A23L 29/10; A23J 3/16

(52) U.S. Cl. CPC A23D 7/0053; A23J 3/16; A23L 29/10; A23L 11/05

(57) ABSTRACT

This specification discloses plant-based emulsifiers comprising a pulse protein and having Brix of from about 5° to about 60°. Also disclosed are emulsifier compositions including plant-based emulsifiers and a starch. Also disclosed are edible composition comprising the plant-based emulsifiers. Also disclosed are edible compositions having a plant-based emulsifier and an emulsion of oil and water having high oil content.

### CROSS-REFERENCE TO RELATED APPLICATION

This application claims the benefit of U.S. Provisional Patent Application No. 62/863,147, filed Jun. 18, 2019, which is incorporated by reference herein in its entirety.

The present invention relates to emulsifying compositions and more specifically to emulsifying compositions using plant proteins.

An emulsion is a fine dispersion of droplets of one liquid in another. The two liquids are neither soluble nor miscible. Common emulsions are oil-in-water emulsions and water-in-oil emulsions. Many edible compositions, for example sauces or mayonnaise, are emulsions. In water-oil emulsions, the interface between the two liquids is stabilized using an emulsifier having hydrophilic and lipophilic regions. Common emulsifiers for edible compositions include monoglycerides, diglycerides, egg proteins, and modified starches such as octenyl-succinic acid modified starches (OSA-starches). Such emulsifiers may be disfavored in some uses as not being clean label or being from animal sources.

The technology described in this application pertains to plant-protein based emulsifiers, which for convenience are called plant-based emulsifiers. In any embodiment the plant protein useful in a plant-based emulsifier is obtained from a pulse. Within this specification the term “pulse” refers to the seeds of a legume plant. In various embodiments the disclosed plant-based emulsifiers are aqueous solutions, mixtures, or dispersions. In various embodiments the disclosed plant-based emulsifiers have high or low solids content. In various embodiments the disclosed plant-based emulsifiers can be mixed with stabilizers such as thermally inhibited starches. The plant-based emulsifiers described in this application may be used in edible compositions that include emulsions, including emulsions of oil and water.

The technology disclosed in this specification pertains to composition that are plant-based emulsifiers. In any embodiment a plant-based emulsifier comprises a pulse protein and water, consists essentially of a pulse protein and water, or consists of a pulse protein and water. Sources of pulse protein useful in the disclosed plant-based emulsifiers include unmilled pulses, pulse flours, pulse protein concentrates, pulse protein isolates, and mixtures thereof. Sources of pulse protein useful in the disclosed plant-based emulsifiers include but are not limited to pea, lentils, beans, such as, for example including but not limited to fava beans, lupin beans, adzuki beans, black beans, soybeans, anasazi beans, garbanzo beans (chickpeas), kidney beans, lima beans and mixtures thereof.

In any embodiment disclosed in this specification, a plant-based emulsifier includes protein from whole, or milled chickpeas (including chick pea flours, chick pea protein concentrates, and chick pea protein isolates).

In any embodiment disclosed in this specification, a plant-based emulsifier includes protein from whole, or milled peas (including pea flours, pea protein concentrates, and pea protein isolates).

In any embodiments, a plant-based emulsifier has solids content measureable in degrees Brix of at least about 5°. In some embodiments described in this specification, a plant-based emulsifier has relatively low solids (which may be referred to within this specification as a dilute plant-based emulsifier) of from about 5° to about 10° ′ or from about 5° to about 9°, or from about 5° to about 8°, or from about 5° to about 7°, or from about 6° to about 8°, or from about 6° to about 9°. In any embodiment a dilute plant-based emulsifier has a solid content of from about 6° to about 8° Brix.

In some other embodiments described in this specification, a plant-based emulsifier has relatively high solids content (which may be referred to within this specification as a concentrated plant-based emulsifier) of at least about 30°, or at least about 35°, or from about 30° to about 60°, or from about 30° to about 50°, or from about 30° to about 40°. In any embodiment described in this specification a concentrated plant-based emulsifier has solids content of from about 35° to about 40° Brix. In any embodiment described in this specification, a concentrated plant-based emulsifier has from about 36° to about 38° Brix.

In any embodiment described in this specification, a concentrated plant-based emulsifier has one or two total solids content of from about 5% to about 20% (w/w), or from about 10% to about 20% or from about 13% to about 20%, or from about 13% to about 17% (w/w).

In any embodiment described in this specification a plant-based emulsifier is obtained by soaking an unmilled pulse, pulse flour, pulse protein concentrate, or pulse protein isolate, in water and separating the liquid phase from the solid phase and retaining the liquid phase. The liquid phase may be used as the plant-based emulsifier and may include one or more of plant protein (including globulins and albumins) and plant saponin. In certain embodiments, the liquid phase may be further processed to alter the content or structure of the components of the plant-based emulsifier. For example, further processing may include heating. In further embodiments, processing may include filtering, for example by ion exchange chromatography, dialysis, microfiltration, ultrafiltration, reverse osmosis, and combinations thereof.

In another aspect the technology pertains to compositions that are useful in emulsions (for convenience referred to herein as “emulsifier compositions”). In embodiments an emulsifier composition includes a plant-based emulsifier and an added starch (for convenience referred to herein as emulsifier compositions). Added starch useful in the described emulsifier compositions may come from any source, including but not limited to pulses, corn, tapioca, sago, rice and mixtures thereof as well as high amylose and low amylose variants of these plants. Added starches may include native and modified starches. In any embodiment of the described emulsifier compositions a starch is insoluble but is modified to increase process tolerance. For example a starch may be an inhibited starch (starches that resist swelling), such as, for example starches that include phosphate linking (from POCl₃, STMP, STPP, and mixes thereof) or adipate crosslinking. Starches may also be inhibited using physical processes, such as thermal inhibition (e.g. as described in WO 95/04082) and thermal annealing. In any embodiment of the described emulsifier compositions the added starch may be from the same or different botanical source as the protein. In any embodiment an emulsifier composition, as described in this specification, includes a plant-protein component selected from the group consisting of chickpea protein, a pea protein, and mixtures thereof in addition to an added starch component selected from the group consisting of corn starch, tapioca starch, pea starch (including high amylose and low amylose variants of pea, corn, and tapioca) and mixtures thereof.

In any embodiments an emulsifier composition comprises a pulse protein and a starch, or consists essentially of a pulse protein and starch, or consists of a pulse protein and starch. In any embodiment an emulsifier composition, as described in this specification, includes a plant-based emulsifier, or dilute plant-based emulsifier, and an added starch and has solids content of from about 1% to about 60% and may exist as a slurry, a dispersion, or a suspension. In any embodiment described in this specification, an emulsifier composition includes a plant-based emulsifier, or a dilute plant-based emulsifier, and an added starch and has a solids content greater than 60%, for example between about 60% and 99% and may exist as a powder or cake. In embodiments, the described emulsifier composition has starch content (whether added or not) of from about 0.05 to about 60% (w/w) or about 0.1 to about 60%, or from about 0.5 to about 60%, or from about 0.5 to about 50%, or from about 0.5 to about 40%, or from about 0.5 to about 30%, or from about 0.5 to about 20%, or from about 0.5 to about 10%.

In any embodiment, an emulsifier composition, as described in this specification, includes a plant-based emulsifier, or dilute plant based emulsifier and a starch added in an amount of from about 0.5% to about 5%, or from about 0.5% to about 2.5%, or from about 0.5% to about 2%, or from about 0.5% to about 1.5%, or from about 0.5% to about 1.25%, or from about 0.5% to about 1%. In any embodiment, an emulsifier composition, as described in this specification, includes a plant-based emulsifier, or dilute plant-based emulsifier and a starch added in an amount of from about 0.75% to about 1.2%.

The technology disclosed in this specification also pertains to methods of making a plant-based emulsifier. In any embodiment a plant-based emulsifier, as described in this specification, is obtained by a process including soaking at least a portion of a pulse, for example whole or split pulse, or milled pulse, or pulse protein concentrate or pulse protein isolate, which, for convenience, are referred to in this specification collectively “pulse material.”

In any embodiment a plant-based emulsifier, as described in this specification, is obtained in a process including soaking pulse material in water for enough time for at least some of the soluble and/or fine material components within the pulse material to dissolve or disperse in the water. For example, pulse material may be soaked for at least about 10 minutes. The pulse material may be soaked in water at any temperature. In any embodiment described in this specification, pulse material is soaked at a temperature below the gelatinization temperature of starch within the pulse material for example at from about 20° to about 60° C. In any embodiment, a method for making a plant-based emulsifier, as described in this specification, includes soaking pulse material to obtain a solution having from about 5° to about 10°, or from about 5° to about 9°, or from about 5° to about 8°, or from about 5° to about 7°, or from about 6° to about 8°, or from about 6° to about 9°. In any embodiment a dilute plant-protein based emulsifier has a solid content of from about 6° to about 8° Brix.

In any embodiment a plant-based emulsifier, as described in this specification is obtained in a process including soaking a pulse material to obtain a solid phase and an aqueous phase and separating the aqueous phase from the solid phase. In embodiments said aqueous phase comprising dissolved pulse protein may be separated from the remaining solids using any suitable means, for example, including but not limited to, centrifugal decantation. The aqueous phase may be used as a plant-based emulsifier or may be further processed for example to remove salts, or to remove various portions of the soluble or dispersed fine material within the suspension. In any embodiment a plant-based emulsifier may be obtained as part of a process to recover a pulse protein isolate.

Methods for isolating plant protein from starch and other components of a plant seed or tuber are described for example in U.S. Pat. No. 4,144,087, which is incorporated herein by reference in its entirety. In an illustrative method a process uses milled pulse seeds to and separates, among other things starch and fiber from protein using an aqueous slurry. The processes provide a protein rich aqueous system, which, depending on process may be a dispersion, a suspension or a solution. A protein rich material (for convenience called a sediment) may be recovered from the aqueous stream using for example, but not limited to (and depending on the specific state of the aqueous system) flocculation, precipitation or settling. Not all protein is recovered in the sediment; some protein remains in the aqueous system (for convenience called a supernatant). The supernatant may be separated from the sediment to obtain a plant-based emulsifier as described in this specification.

In any embodiment, of a method for making a plant-based emulsifier, as described in this specification, includes further processing a supernatant obtained in any manner, including from a protein isolate recovery process or from a process including soaking pulse matter to obtain a supernatant, heating the supernatant in a step that does not concentrate the supernatant, and optionally a filtering, and optionally concentrating the supernatant.

In any embodiment, a method for making a dilute plant-based emulsifier, includes heating a supernatant obtained from pulse material to obtain a dilute plant-based emulsifier having Brix of from about 5° to about 10°, or from about 5° to about 9°, or from about 5° to about 8°, or from about 5° to about 7°, or from about 6° to about 8°, or from about 6° to about 9°.

In any embodiment, a method of making a plant-based emulsifier, as described in this specification includes concentrating a supernatant using any method useful for increasing the solids content of a dilute solution or dispersion. In various embodiments a pulse protein extract can be concentrated using processes known in the art. In some embodiments the concentration step is an evaporation step, a filtration step, or a combination of the two. In some embodiments the concentration step uses one or more of ultrafiltration, nanofiltration, forward osmosis, or reverse osmosis filtration.

In any embodiment, a method of making a plant-based emulsifier, as described in this specification includes concentrating a supernatant to obtain a plant-based emulsifier having Brix of at least about 30°, or at least about 35°, or from about 30° to about 60°, or from about 30° to about 50°, or from about 30° to about 40°. In any embodiment described in this specification a concentrated plant-protein emulsifier has solids content of from about 35° to about 40° Brix. In any embodiment a described in this specification, a concentrated plant-protein emulsifier has from about 36° to about 38° Brix.

In any embodiment described in this specification, a concentrated plant-based emulsifier has solids content 5% to about 20% (w/w), or from about 10% to about 20%, or from about 13% to about 20%, or from about 13% to about 17% (w/w). In any embodiment described in this specification, a concentrated plant-based emulsifier includes from about 1% to about 10% soluble solids by weight, or from about 3% to about 7%, or from about 4% to about 6%.

In embodiments the plant-based emulsifier includes no added starch or includes less than 0.05% starch (w/w), or less than 0.01%, or essentially 0% starch.

In another aspect this specification disclose uses of a pulse protein extract in edible compositions and edible compositions comprising a pulse protein extract. In other embodiments a pulse protein extract is used as an emulsifier in an edible composition. In various embodiments an edible composition comprising a pulse protein extract is an emulsion. In embodiments an edible composition comprises pulse protein extract and a starch. In some embodiments an mixture comprising a pulse protein extract and a starch is used to provide long term stable viscosity to an edible composition. In various embodiments edible composition comprises a pulse protein extract and an inhibited starch or a thermally inhibited starch. In various embodiments an edible composition comprises a pulse protein extract and an inhibited and stabilized starch, such as a starch modified with propylene oxide and phosphorous oxychloride, or acetic anhydride and adipic anhydride.

The technology disclosed in this specification also pertains to edible compositions comprising a plant-based emulsifier. In certain embodiments such include a plant-based emulsifier in any amount, or in amounts between 1 and 99% by weight of the composition. In various embodiments an edible composition comprises a plant-based emulsifier and one or more other edible ingredients. In various embodiments, the edible composition is an edible emulsion comprising a plant-based emulsifier, a liquid aqueous component, and a liquid lipid component. In various embodiments the edible composition is an oil-in-water emulsion or a water-in-oil emulsion comprising a plant-based emulsifier and optionally a fourth edible ingredient.

In some embodiments an edible composition, as described in this specification, includes an emulsion of oil and water, a starch, and either a plant-based emulsifier or dilute plant-based emulsifier. In embodiments the edible composition comprises a dilute pulse protein extract in an amount of from 15% to 20% by weight of the composition. In embodiment the edible composition further comprises a starch or inhibited starch or thermally inhibited starch in an amount from about 0.5% to about 5% by weigh of the composition, or from about 0.5% to about 2.5%, or from about 0.5% to about 2%, or from about 0.5% to about 1.5%, or from about 0.5% to about 1.25%, or from about 0.5% to about 1%, or from about 0.75% to about 1.2%. In embodiments the edible composition has oil content from about 65 to about 80% by weight of the composition, or from about 70% to about 80%, or from about 71% to about 80%, or from about 73% to 80%, or from about 75% to about 80%. In embodiments an edible composition has oil content from about 70% to about 75% by weight of the composition. In embodiment an edible emulsion has oil content from 73% to about 75% by weight of the composition. In still other embodiments, the edible composition has oil content of less than about 5, or from about 3 to about 5.

In some embodiments an edible composition, as described in this specification, includes an emulsion of oil and water, a plant-based emulsifier, or concentrated plant-based emulsifier in an amount from about 1% to about 10% by weight of the composition, or from about 1% to about 5%, or from about 1% to about 3%, or from about 3% to about 5%. In embodiments the edible composition has oil content from about 65 to about 80% by weight of the composition, or from about 70% to about 80%, or from about 71% to about 80%, or from about 73% to 80%, or from about 75% to about 80%. In embodiments an edible composition has oil content from about 70% to about 75% by weight of the composition. In embodiments an edible emulsion has oil content from 73% to about 75% fat by weight of the composition. In still other embodiments, the edible composition has oil content of less than about 5, or from about 3 to about 5. In embodiments the edible emulsion includes no added starch or includes less than 0.05% starch (w/w), or less than 0.01% or essentially 0%.

In any embodiment an edible composition is a sauce, or a dressing, or mayonnaise, or a frozen composition such as ice cream (hard back or soft back) or ice cream like dessert (frozen yogurt, frozen custard) or other frozen emulsion, a confection, a baked goods, a filling for a edible composition including fruit filings or fruit preps.

In any embodiment an edible composition is an emulsion of oil and water having a viscosity from about 1,000 to about 50,000 cP, or from about 15,000 to about 30,000 cP, or from about 15,000 to about 25,000, after 1 day, 1 month, or 3 months storage at 4° C.

In embodiments an edible composition, as described in this specification, is an emulsion of oil and water having from about 70% to about 80% oil by weight to the composition, or from about 70 to about 75% and having a droplet size distribution from about 5% to about 10% of the particle have a size between 20 and 22 microns, or from about 8% to about 10%, or from about 8% to about 12%, or from about 8% to about 15%, and optionally after 1 day's, 1 month's or 3 months' storage at 4° C. In embodiments an edible composition, as described in this specification, is emulsion of water and oil having a mean droplet size from about 15 to about 25 microns, or from about 17 to about 22 microns, or from about 20 to about 22 microns after 1 day's, 1 month's or 3 months' storage at 4° C.

The technology also pertains to use of a concentrated plant-based emulsifier to improve an edible composition that includes emulsions of oil and water. Such improvements may be obtained by substituting a concentrated plant-based emulsifier for a dilute plant-based emulsifier. In various embodiments edible emulsions substituting a concentrated plant-based emulsifier for a dilute plant-based emulsifier have increased viscosity, increased viscosity stability, and/or a decreased mean droplet size. All such improvements are achieved even though the overall moisture content of the emulsion is maintained.

In embodiments, an edible composition, as described in this specification, includes an emulsion of oil and water and a concentrated plant-based emulsion having viscosity from 10,000 cP to 30,000 cP, or at least 10,000 cP, or at least 15,000 cP, or at least 20,000, or at least 25,000 cP, or at least 30,000 cP higher than the same edible composition using a dilute plant-based emulsion. The foregoing increased viscosity is observed after 1, 30, and 90 day's storage at 4° C.

In other embodiments, an edible composition, as described in this specification, including an emulsion of oil and water and a concentrated plant-based emulsion has a mean droplet size that is at least about 2 microns or at least about 5 microns smaller than the same edible composition using a dilute plant-based emulsion. The foregoing reduced mean droplet size is observed after 1, 30, and 90 day's storage at 4° C.

The forgoing viscosity increase and reduction in mean particle size are achievable in edible composition having equal oil content, equal water content, and equal emulsifier solids content (as measured by Brix). For example, in an illustrative test embodiments may include about 75% oil (w/w) and about 18% (w/w) dilute plant-based emulsifier having Brix of between about 7° and about 8° and no additional water. An alternate illustrative test embodiment may include about 75% oil (w/w), about 3.75% (w/w) concentrated plant-based emulsifier having Brix of between about 38° and about 39° and 14.25% water. In comparing the illustrative embodiments, the concentrated plant-based emulsifier is concentrated to a Brix 5-times higher than the dilute plant-based emulsifier but the concentrated plant-based emulsifier is used in amount about 5-times less than the dilute plant-based emulsifier. In certain embodiments, the edible composition using the concentrated plant-based emulsifier has added water equal so that content of the edible composition using the concentrated plant-based emulsifier is equal to the water content of the edible composition using the dilute plant-based emulsifier.

In any embodiment, this specification discloses a method for making an edible composition including an emulsion of oil and water, the method comprising: substituting a concentrated plant-based emulsifier for at least a portion of a dilute plant-based emulsifier. In any embodiment of the method, the concentrated plant-based emulsifier is substituted for from about 1% to about 100% of the dilute plant-based emulsifier, or at least about 10%, or at least about 20%, or at least about 25%, or at least about 30%, or at least about 33%, or at least about 40%, or at least about 50%, or at least about 60%, or at least about 67%, or at least about 70%, or at least about 75%, or at least about 80%, or at least about 90%. In any embodiment the concentrated plant-based emulsifier is substituted for at least about 95% of the dilute plant-based emulsifier. In any embodiment the concentrated plant-based emulsifier is substituted for about 100% of the dilute plant-based emulsifier.

In any embodiment of the method for making an edible composition described in this specification, the concentrated plant-based emulsifier is substituted for the dilute plant-based emulsifier such that the Brix of the concentrated plant-based emulsifier is no more than about equal to the Brix of the dilute plant-based emulsifier, or is about 10% less than the Brix of the dilute plant-based emulsifier, or is about 15%, or is about 20% less, or is about 25% less, or is about 30% less.

In any embodiment of the method for making an edible composition described in this specification, the concentrated plant-based emulsifier is substituted for the dilute plant-based emulsifier such that the water content of the edible composition comprising the concentrated plant-based emulsifier is about equal to the water content of the edible composition comprising the dilute plant-based emulsifier.

In any embodiment of the method for making an edible composition described in this specification, the concentrated plant-based emulsifier is substituted for the dilute plant-based emulsifier such that the oil content of the edible composition comprising the concentrated plant-based emulsifier is about equal to the oil content of the edible composition comprising the dilute plant-based emulsifier.

“Pulse flour” as used in this specification means milled pulse material having essentially the same ratio of constituents as exist in an unmilled pulse. Such constituents include but are not limited protein, fiber, and starch. For comparative purposes, and without intending to be bound by specific percentages, a pulse flour generally has less than 50% protein.

“Pulse protein concentrate” as used in this specification means pulse material that compared to a pulse flour has increased protein and decreased starch and flour. Pulse protein concentrates can be made using air classification processes. For comparative purposes, and without intending to be bound by specific percentages, a pulse protein concentrate generally has from about 50% to about 70% protein by weight.

“Pulse protein isolate” as used in this specification means a pulse that, compared to a pulse flour, has little starch and is substantially protein. Pulse protein isolates can be in slurry systems using hydrocyclones or isoelectric precipitation. For comparative purposes, and without intending to be bound by specific percentages, a pulse protein isolate generally has greater than about 70% protein by weight.

“High amylose” as used in this specification means higher than about 50% apparent amylose content by weight.

“Low amylose” as used in this specification means less than 3% or essentially 0% apparent amylose content by weight.

Use of “about” to modify a number in this specification is meant to include the number recited plus or minus 10%. Where legally permissible recitation of a value in a claim means about the value. Use of about in a claim or in the specification is not intended to limit the full scope of covered equivalents.

Use of “essentially” to modify a number, for example essentially 0, is meant to include minimal amounts of contaminant below a specifically recited amount. The amount of contaminant may or may not be measurable.

Recitation of the indefinite article “a” or the definite article “the” in this specification is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The technology is further described in the following aspects, which are intended to be illustrative, and are not intended to limit the full scope of the claims and their equivalents.

In a first aspect, the technology pertains to a plant-based emulsifier comprising: water and a pulse protein and having Brix of at least 5°, or at least about 30°, or at least about 35°, or from about 30° to about 60°, or from about 30° to about 50°, or from about 30° to about 40°, or from about 35° to about 40° or from about 36° to about 38°, the pulse protein optionally being pea protein, a chick pea protein or a mixture thereof.

In a second aspect the technology pertains to the plant-based emulsifier of the first aspect having total solids content of from about 5% to about 20% (w/w), or from about 10% to about 20%, or from about 13% to about 20%, or from about 13% to about 17% (w/w), and optionally a soluble solids content of from about 1% to about 10% soluble solids by weight, or from about 3% to about 7%, or from about 4% to about 6%.

In a third aspect, the technology pertains to the plant-based emulsifier of the first or second aspects having Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

In a fourth aspect, the technology pertains to the plant-based emulsifier of any one of the first through third aspects further comprising a saponin.

In a fifth aspect, the technology pertains to the plant-based emulsifier of any one of the first through fourth aspects wherein the emulsifier is obtained from a process including soaking a milled or unmilled pulse in water to form a liquid phase and a solid phase, separating the liquid phase from the solid phase and retaining the liquid phase.

In a sixth aspect, the technology pertains to the plant-based emulsifier of any one of the first to fifth aspects having less than 0.05%, or less than about 0.01%, or essentially 0% starch.

In a seventh aspect, the technology pertains to an emulsifier composition comprising: a plant-based emulsifier as described in any of the first to sixth aspects and a modified or unmodified starch, which optionally is an inhibited or thermally inhibited starch, and which optionally is selected from the group consisting of corn starch, tapioca starch, pea starch, low amylose corn starch or low amylose tapioca starch and mixtures thereof.

In an eighth aspect, the technology pertains to the emulsifier composition of seventh aspect having a starch content of from about 0.05% to about 60% by weight, or from about 0.5% to about 5%, or from about 0.5% to about 2.5%, or from about 0.5% to about 2%, or from about 0.5% to about 1.5%, or from about 0.5% to about 1.25%, or from about 0.5% to about 1%, or from about 0.75% to about 1.2%.

In a ninth aspect, the technology pertains to the emulsifier composition of the seventh or eighth aspects wherein the starch is from a different botanical source as the protein in the plant-based emulsifier.

In a tenth aspect, the technology pertains to an edible composition comprising the plant-based emulsifier of any one of the first to sixth aspects or the emulsifier composition of any one of the seventh to ninth aspects and a second edible ingredient, and optionally starch content in an amount of from about 0.5% to about 5%, or from about 0.5% to about 2.5%, or from about 0.5% to about 2%, or from about 0.5% to about 1.5%, or from about 0.5% to about 1.25%, or from about 0.5% to about 1%, or from about 0.75% to about 1.2%.

In an eleventh aspect, the technology pertains to the edible composition of the tenth aspect further comprising emulsion of oil and water, and optionally wherein the oil is used in an amount selected from the group consisting of (a) from about 65 to about 80% by weight of the composition, or from about 70% to about 80%, or from about 71% to about 80%, or from about 73% to 80%, or from about 75% to about 80%, or from about 70% to about 75%, or from 73% to about 75% and (b) from about 20% to about 40%, or from about 25% to about 35%, or from about 27% to about 33%.

In a twelfth aspect, the technology pertains to the edible composition of the tenth or eleventh aspects wherein the plant-based emulsifier is used in an amount of from about 1 to about 20% by weight of the composition, or 1% to about 10%, or from about 1% to about 5%, or from about 1% to about 3%, or from about 3% to about 5%, or from about 15% to about 20%.

In a thirteenth aspect, the technology pertains to the edible composition of tenth to twelfth aspects having pH of less than 5 or from about 3 to about 5.

In a fourteenth aspect the technology pertains to the edible composition of any one of the tenth to thirteenth aspects having a viscosity of from about 1,000 to about 50,000 cP, or from about 15,000 to about 30,000 cP, or from about 15,000 to about 25,000 cP after 1 day, 1 month, or 3 months storage at 4° C.

In a fifteenth aspect, the technology pertains to the edible composition of any one of the tenth to thirteenth aspects having a droplet size describe by the group consisting of one or more of: (a) a droplet size distribution wherein from about 5% to about 10% of the droplets are from about 20 to about 22 microns, or from about 8% to about 10%, or from about 8% to about 12%, or from about 8% to about 15%; or (b) a mean droplet size of from about 15 to about 25 microns, or from about 17 to about 22 microns, or from about 20 to about 22 microns; wherein optionally the droplet size description is obtained after one or more of 1 day, 1 month or 3 months' storage at 4° C.

In a sixteenth aspect, the technology pertains to a method of making a pulse protein extract comprising: (a) soaking a pulse material in water to obtain solid phase and a liquid phase, (b) separating the solid phase from the liquid phase, and (c) retaining the liquid phase, wherein optionally the liquid phase has Brix of from about 5° to about 10°, or from about 5° to about 9°, or from about 5° to about 8°, or from about 5° to about 7°, or from about 6° to about 8°, or from about 6° to about 9°, or from about 6° to about 8° Brix.

In a seventeenth aspect, the technology pertains to the method of the sixteenth aspect further comprising heating the retained liquid phase while maintaining the Brix.

In an eighteenth aspect, the technology pertains to the method of the sixteenth or seventeenth aspects wherein the liquid phase is obtained as part of a process to recover a pulse protein isolate.

In a nineteenth aspect, the technology pertains to the method of any one of the sixteenth to eighteenth aspects further comprising concentrating the retained liquid to obtain a liquid having Brix of at least 5°, or at least about 30°, or at least about 35°, or from about 30° to about 60°, or from about 30° to about 50°, or from about 30° to about 40°, or from about 35° to about 40° or from about 36° to about 38°.

In a twentieth aspect, the technology pertains to a method of making an edible composition as described in any foregoing aspect, the edible composition comprising an oil and water emulsion and a plant-based emulsifier, as described in any of the foregoing aspects, the method comprising: substituting, for at least a portion of the plant-based emulsifier, a concentrated plant-based emulsifier, as described in any of the foregoing aspects wherein the concentrated plant-based emulsifier has increased Brix compared to the plant-based emulsifier.

In a twenty-first aspect, the technology pertains to the method of the twentieth aspect wherein the concentrated plant-based emulsifier is substituted for from about 1% to about 100% of the plant-based emulsifier, or at least about 10%, or at least about 20%, or at least about 25%, or at least about 30%, or at least about 33%, or at least about 40%, or at least about 50%, or at least about 60%, or at least about 67%, or at least about 70%, or at least about 75%, or at least about 80%, or at least about 90%, or at least about 95%, or for about 100%.

In a twenty-second aspect, the technology pertains to the method of the twentieth or twenty-first aspects wherein the concentrated plant-based emulsifier is substituted for the plant-based emulsifier such that the concentrated plant-based emulsifier has Brix that is no more than about equal to the Brix of the dilute plant-based emulsifier, or is about 10% less than the Brix the dilute plant-based emulsifier, or is about 15%, or is about 20% less, or is about 25% less, or is about 30% less.

In a twenty-third aspect, the technology pertains to the method of any one of the twentieth to twenty-second aspects wherein the concentrated plant-based emulsifier is substituted for the dilute plant-based emulsifier such that the water content of the edible composition comprising the concentrated plant-based emulsifier is about equal to the water content of the edible composition comprising the dilute plant-based emulsifier.

In a twenty-fourth aspect, the technology pertains to the method of any one of the twentieth to twenty-third aspects wherein the concentrated plant-based emulsifier is substituted for the dilute plant-based emulsifier such that the oil content of the edible composition comprising the concentrated plant-based emulsifier is about equal to the oil content of the edible composition comprising the dilute plant-based emulsifier.

In a twenty-fifth aspect, the technology pertains to the method of any one of the twentieth to twenty-fourth aspects wherein the composition comprising the concentrated plant-based emulsion is different than edible composition including the plant-based emulsion the difference being selected from the group consisting of: (a) the composition comprising the concentrated plant-based emulsion has increased viscosity, (b) the composition comprising the concentrated plant-based emulsion has decreased mean particle size, and (c) mixtures thereof.

The technology is further described by the following examples, which are intended to be illustrative and are not intended to limit the full scope of the claims or their equivalents.

### Formulations

Following is a formula for a low-fat emulsions.

TABLE 1
Low-fat emulsion formula

| Paste Ingredients | % |
|---|---|
| Water | 43.0925 |
| Sugar | 11.51 |
| Vinegar (120 Grain) | 8.13 |
| Thermally inhibited starch | 4.5 |
| Plant-based emulsifier | 1.0 |
| (dilute or concentrated | |
| Salt | 1.69 |
| Preservatives | 0.0775 |
| Soybean Oil | 30.00 |
| Total | 100 |

Additional formulations for high-fat emulsions are provided in Tables 2 and 4 below.

### Procedures

Applicants evaluated the viscosity and the stability of viscosity of edible compositions including emulsions of oil and water using both dilute and concentrated plant-based emulsifiers. It was observed that in high-oil (greater than about 70%) compositions using dilute plant-based emulsifiers required additional stabilization from an inhibited starch. It was further observed that compositions using concentrated plant-based emulsifiers did not require use of starch stabilizers despite having equal liquid content. Such observations were made according to the following procedures.

Viscosity was measured using a Brookfield DV2T w/heliopath moving upward using T spindle C for 30 seconds at 20 RPM.

Droplet size was measured using a Beckman Coulter LS 13 320 SW Laser Based Particle Size Analyzer.

Brix was measured using a refractometer.

Total solids content is measured by comparing initial and weight of 1 gram sample of solution with sample after drying at 130° C. for 4 hours. Percent solids is the weight of residue/sample weight×100.

Emulsions were made by first dry blending all ingredients. Water and vinegar were combined in a conventional kitchen stand mixer mixing bowl. The dry mix was added to the water and vinegar mixture and mixed until homogenous. Oil was slowly added while mixing at medium speed. The mass is then transferred to a Scott Turbon mixer for high shear homogenization. (30 hertz for 2 minutes).

### EXAMPLE 1 EDIBLE COMPOSITIONS USING DILUTE PLANT-BASED EMULSIFIERS

Edible compositions including an emulsion of oil and water, dilute plant-based emulsifier and starch were made using the formulas reported in Table 2. All compositions used a dilute plant-based emulsion having Brix of from about 7° to about 8°.

TABLE 2
Edible Composition: Formulas

| | Sample 1 | Sample 2 | Sample 3 | Sample 4 | Sample 5 |
|---|---|---|---|---|---|
| Ingredient | (wt %) | (wt %) | (wt %) | (wt %) | (wt %) |
| Sugar | 2.7 | 2.7 | 2.7 | 2.7 | 2.7 |
| Salt | 1.2 | 1.2 | 1.2 | 1.2 | 1.2 |
| Preservatives | 0.175 | 0.175 | 0.175 | 0.175 | 0.175 |
| Inhibited Starch | 1.0 | 0.7 | 0.5 | 0.3 | 0.0 |
| Colorant | 0.002 | 0.002 | 0.002 | 0.002 | 0.002 |
| Flavorants | 0.71 | 0.71 | 0.71 | 0.71 | 0.71 |
| Water | 3.213 | 3.513 | 3.713 | 3.913 | 4.213 |
| Vinegar | 2 | 2 | 2 | 2 | 2 |
| Dilute Pulse-based | 18 | 18 | 18 | 18 | 18 |
| Emulsifier | | | | | |
| Soybean oil | 71 | 71 | 71 | 71 | 71 |
| Total | 100 | 100 | 100 | 100 | 100 |

Viscosity of samples was measured after 24 hours storage at 4° C. Results are reported in Table 3.

TABLE 3
Edible Composition: Viscosity Measurements

| | Viscosity |
|---|---|
| Sample No. | (CP) |
| 1 | 25,700 |
| 2 | 20,950 |
| 3 | 17,750 |
| 4 | 13,750 |
| 5 | 8,200 |

### EXAMPLE 2 EDIBLE EMULSIONS USING CONCENTRATED PLANT-BASED EMULSIFIER

Edible compositions including an emulsion of oil and water in addition to dilute or concentrated plant-based emulsifier were made using the formulas reported in Table 4. Dilute plant-based emulsifiers had Brix between 7° and 8°.

TABLE 4
Edible Composition: Formulas

| | Sample 6 | Sample 7 | Sample 8 |
|---|---|---|---|
| Ingredient | (wt %) | (wt %) | (wt %) |
| Salted Egg Yolk | 7.00 | | |
| Dilute Plant-based Emulsifier | | 17.99 | |
| Conc. Plant-based Emulsifier | | | 3.71 |
| Water | 10.99 | 0 | 14.28 |
| Soybean oil | 75 | 75 | 75 |
| Sugar | 3.00 | 3.00 | 3.00 |
| Vinegar (120 grain) | 3.00 | 3.00 | 3.00 |
| Salt | 1.00 | 1.00 | 1.00 |
| EDTA | 0.01 | 0.01 | 0.01 |
| Total | 100 | 100 | 100 |

Sample 6 (egg yolk emulsifier) was observed to have viscosity of from 20,000 to 25,000 cP after storage at 4° C. for 1, 30 and 90 days. Sample 7 was observed to have viscosity of from 10,000 to 15,000 cP after storage at 4° C. for 1, 30 and 90 days. Sample 8 was observed to have viscosity of from 25,000 to 35,000 cP after storage at 4° C. for 1, 30 and 90 days.

1. A plant-based emulsifier comprising: water and a pulse protein, wherein the emulsifier has a Brix, at least about 30°.

2. The plant-based emulsifier of claim 1, having total solids content of from about 5% to about 20% (w/w).

3. (canceled)

4. The plant-based emulsifier of claim 1, further comprising a saponin.

5. The plant-based emulsifier of claim 1, being obtained from a process comprising soaking a milled or unmilled pulse in water to form a liquid phase and a solid phase, separating the liquid phase from the solid phase and retaining the liquid phase, and removing liquid from the liquid phase to obtain a solution having Brix of at least about 30°, or at least about 35°, or from about 30° to about 60°, or from about 30° to about 50°, or from about 30° to about 40°, or from about 35° to about 40°, or from about 36° to about 38°.

6. The plant-based emulsifier of claim 1, having less than 0.05% starch (wt. %).

7. An emulsifier composition comprising: a plant-based emulsifier comprising water and a pulse protein and wherein the emulsifier has a Brix at least about 30°;
and a modified an inhibited starch or a thermally inhibited starch.

8. The emulsifier composition of claim 7 having a starch content from about 0.05% from about 0.5% to about 5%.

9. The emulsifier composition of claim 7, wherein the starch is from a different botanical source than the protein in the plant-based emulsifier.

10. An edible composition comprising:
the plant-based emulsifier: comprising water and a pulse protein and wherein the emulsifier has a Brix at least about 30°,
and a starch content in an amount from about 0.5% to about 5%, wherein the starch is an inhibited starch or a thermally inhibited starch; and
wherein the edible composition is an oil in water emulsion having an oil content in a ranges selected from the group consisting of (a) from about 65% to about 80% and (b) from about 20% to about 40%.

11. (canceled)

12. The edible composition of claim 10 wherein the plant-based emulsifier is used in an amount from about 1% to about 5%.

13. (canceled)

14. (canceled)

15. The edible composition of any one of claim 10 having a mean droplet size of from about 15 to about 25 microns.

16-19. (canceled)

20. A method of making an edible composition, being an oil and water emulsion that comprises and a plant-based emulsifier the method comprising: substituting, for at least a portion of the plant-based emulsifier, a concentrated plant-based emulsifier having a Brix of at least about 30°, wherein the concentrated plant-based emulsifier has increased Brix relative to the plant-based emulsifier and wherein the water content of the edible composition comprising the concentrated plant-based emulsifier is about equal to the water content of the edible composition comprising the dilute plant-based emulsifier.

21. The method of claim 20 wherein the concentrated plant-based emulsifier is substituted for the plant-based emulsifier in at least about 50%.

22. (canceled)

23. (canceled)

24. The method of claim 20, wherein the concentrated plant-based emulsifier is substituted for the dilute plant-based emulsifier such that the oil content of the edible composition comprising the concentrated plant-based emulsifier is about equal to the oil content of the edible composition comprising the dilute plant-based emulsifier.

25. The method of claim 20, wherein the composition comprising the concentrated plant-based emulsion increased viscosity compared to the edible composition including the plant-based emulsion.

26. The method of claim 20 wherein the composition comprising the concentrated plant-based emulsion edible composition including the plant-based emulsion has decreased mean particle size compared to the edible composition including the plant-based emulsion.

27. The plant-based emulsifier of claim 1 wherein the plant-based emulsifier is a pea protein, a chick pea protein or a mixture thereof.
